(19) United States
(12) Patent Application Publication
(10) Pub. No.: US 2013/0192535 A1
(43) Pub. Date: Aug. 1, 2013

(54) Rubber Dog Toy with Thrower

(71) Applicant: Christopher Scott Smith, Louisville, CO (US)

(72) Inventor: Christopher Scott Smith, Louisville, CO (US)

(21) Appl. No.: 13/360,659

(22) Filed: Jan. 28, 2012

(51) Int. Cl. A01K 29/00; F41B 3/00

(52) U.S. Cl. 119/707

(57) ABSTRACT

Dog retrieval toy consists of both a retrievable component and an attachable throwing arm. The retrievable component is composed entirely of rubber with its symmetry based around a hollow axis. The axis of the retrievable component is designed to fit perpendicularly into the distal gripping fingers of the attachable throwing arm. The axis of the retrievable component is hollow to accommodate treat material as well as decrease production costs by reducing the amount of material. While holding onto the handle of the attachable throwing arm, picking up the retrievable component is accomplished by fitting the retrievable components' axis into the throwing arm's distal gripping fingers by pressing the retrievable component against the ground with the attachable throwing arm. The retrievable component is released from the grip of the throwing arm simply by the force of the throw.

### BACKGROUND OF THE INVENTION

1. Field of the Invention

The present invention relates to dog retrieval toys, and more particularly to retrieval toys that have a throwing component to facilitate the easy and distance which throwing components may be propelled, while minimizing the direct human interaction with the throwing component.

2. Prior Art

Dog retrieval toys in the same field as the present invention are known for their ability to reduce the user's contact with pet slobber on the retrievable component and for allowing a longer throw than can be achieved by the human arm alone. Currently, there are many ball throwing apparati but none that provide the particular hands-free interaction between the throwing arm and retrievable component as the present invention. Because picking up a thrown object that is wet with dog slobber is not desirable, it may limit the number of owner/pet interactions and thusly decreases the amount of exercise enjoyed by pet and owner. A dog retrieval toy that increases pet and owner interaction has been shown to increase the physical and mental health of both.

### SUMMARY OF THE INVENTION

It is therefore an object of the present invention to provide an approach to propelling dog retrieval toys without the necessity for direct human interaction with the retrievable component. The attachable throwing arm component has a proximal handle component to facilitate the ease of human manipulation of the attachable throwing arm. The attachable throwing arm has distal gripping fingers that are designed to connect with the central hollow rubber axis of the retrievable component and between the pliable rubber rings of the retrievable component. This connection is achieved while holding the handle portion attachable throwing arm and pressing the distal gripping fingers portion against the throwing component and the ground, and with the distal gripping fingers between the pliable rubber rings and against the central hollow axis of the retrievable throwing component. The retrievable component is released from the attachable throwing arm by the force generated by user accelerating the attached configuration of attachable throwing arm and retrievable central component in an extended motion much like that used with a fishing pole. The retrievable component is made of durable molded rubber and the attachable throwing arm is made of more rigid injection molded plastic. Both the attachable throwing arm and retrievable component can be made in different colors to appeal to purchaser preference and scaled to different sizes for accommodation to various size dogs.

### BRIEF DESCRIPTION OF THE DRAWINGS

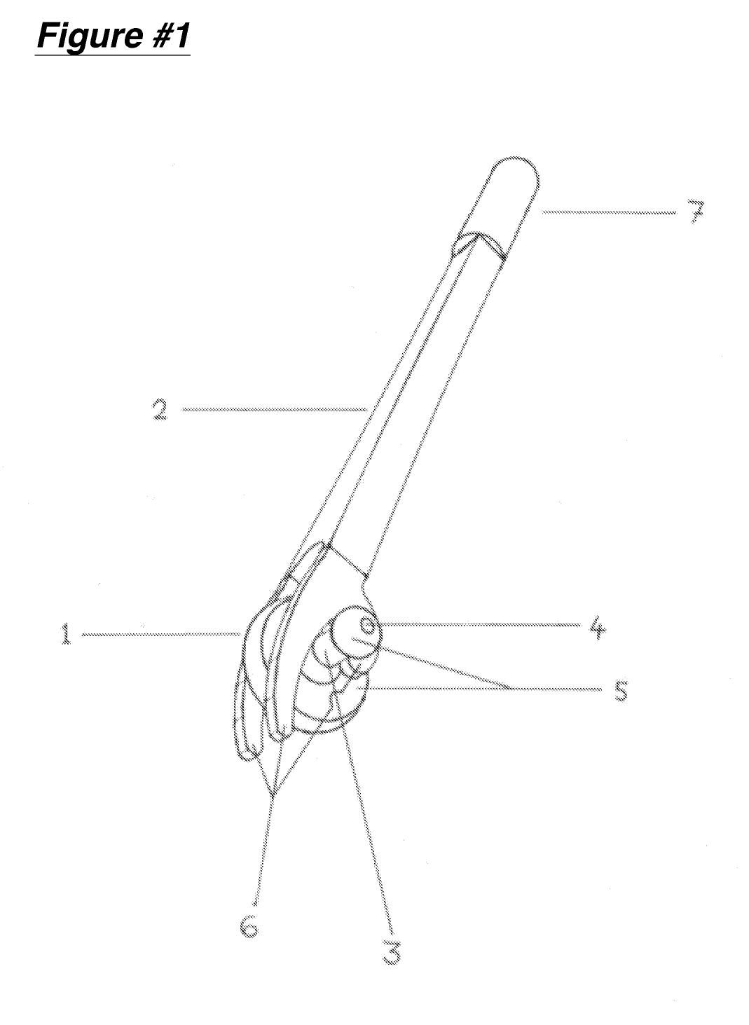

The features of the invention are believed to be novel and the elements characteristic of the invention are set forth with particularity in the claims. For a fuller understanding of the nature and object of the present invention, reference is made to the following detailed description of the preferred embodiments taken in conjunction with the accompanying drawing, wherein FIG. 1 represents the retrievable component and the attachable throwing component in the attached configuration, to show the interaction of the features of the retrievable component and the attachable throwing component which provide for ease of the attachment and detachment of same.

### DETAILED DESCRIPTION OF THE PREFERRED EMBODIMENTS

Referring to FIG. 1, the central axis 3 of the retrievable component 1 has a hollow center core 4 where treat material may be placed and illustrates the design and placement of the pliable rubber rings 5 of the retrievable component 1 and of the gripping fingers 6 of the distal portion of the attachable throwing component 2 that facilitate the ease of which the retrievable component 1 may be picked up by the attachable throwing arm component 2 while holding onto the handle component 7 of the proximal portion of the attachable throwing component 2.

What is claimed is:

1. A dog retrieval toy comprised of a retrievable component and an attachable throwing arm component, said retrievable component composed of a plurality of pliable rubber rings, said rings configured symmetrically along a central hollow rubber axis, where said hollow axis is sided as to readily accommodate the insertion of dog treats, and where said attachable throwing component having a proximal portion and a distal portion and said distal portion having a plurality of anterior and posterior distal gripping fingers, said distal fingers positioned and sized as to secure between said rubber rings along said central hollow rubber axis portion of said retrievable component in an attached configuration with said retrievable component, and to facilitate the disconnection of said attachable throwing arm component from said retrievable component in a detached configuration, and where said proximal portion of said attachable throwing component having a handle portion so as to facilitate the manipulation of said attachable throwing component in said detached configuration and said detached configuration.
